(19) United States
(12) Patent Application Publication
(10) Pub. No.: US 2023/0362796 A1
(43) Pub. Date: Nov. 9, 2023

(54) OPTIMISING SYSTEM INFORMATION ACQUISITION FOR NR DEVICES

(71) Applicant: Panasonic Intellectual Property Corporation of America, Torrance, CA (US)

(72) Inventors: Xuan Tuong TRAN, Singapore (SG); Hidetoshi SUZUKI, Kanagawa (JP); Hongchao LI, Langen (DE); Lei HUANG, Singapore (SG); Yang KANG, Singapore (SG); Libin KOODATHUMKAL MATHEW, Singapore (SG); Tiong Hou TEO, Singapore (SG); Hong Cheng, Michael SIM, Singapore (SG); Yihui LI, Singapore (SG); Yoshihiko OGAWA, Kanagawa (JP); Shotaro MAKI, Kanagawa (JP)

(21) Appl. No.: 18/245,078

(22) PCT Filed: Jun. 5, 2021
(86) PCT No.: PCT/SG2021/050326

§ 371 Date: Mar. 13, 2023

(30) Foreign Application Priority Data
Sep. 16, 2020 (SG) 10202009101S

(51) Int. Cl. H04W 48/12

(52) U.S. Cl. CPC H04W 48/12

(57) ABSTRACT

The present disclosure provides communication apparatuses and communication methods for optimising system information (SI) acquisition for new radio (NR) devices. The communication apparatuses include a communication apparatus which comprises a receiver, which in operation, receives control information relating to a first period and/or a second period; and circuitry, which in operation, acquires system information (SI) in the first period if a first condition is met, or acquires the SI in the second period if a second condition is met.

### TECHNICAL FIELD

The following disclosure relates to communication apparatuses and communication methods for optimising system information (Sl) acquisition for new radio (NR) devices.

### BACKGROUND

New Radio (NR) is a new radio air interface developed by the 3rd Generation Partnership Project (3GPP) for the fifth generation (5G) mobile communications system. With great flexibility, scalability, and efficiency, 5G is expected to address a wide range of use cases including enhanced mobile broadband (eMBB), ultra-reliable low-latency communications (URLLC), and massive machine type communications (mMTC).

One important objective of 5G is to enable connected industries. 5G connectivity can serve as catalyst for next wave of industrial transformation and digitalization, which improve flexibility, enhance productivity and efficiency, reduce maintenance cost, and improve operational safety. Devices in such environment may include for example pressure sensors, humidity sensors, thermometers, motion sensors, accelerometers, actuators, etc. It is desirable to connect these sensors and actuators to 5G networks.

5G connectivity can also serve as catalyst for the next wave smart city innovations. The smart city vertical covers data collection and analysing to more efficiently monitor and control city resources, and to provide services to city residents. Particularly, the deployment of surveillance cameras is not only an essential part of the smart city, but also of factories and industries. In addition, another use case is that of small devices including wearables such as smart watches, rings, eHealth related devices, medical monitoring devices.

It has been shown that Release 15 (Rel--15) New Radio (NR) provides high performance. However, it may be overcomplicated for applications where high throughput, latency, and reliability are not critical. To address the situation, it has been expected that NR specification is extended to support a lighter version of NR for middle-market NR devices including industrial wireless sensors, video surveillances, and wearables. They are considered as the reduced capability (RedCap) devices.

However, there has been no discussion so far concerning optimising Sl acquisition for NR devices.

There is thus a need for communication apparatuses and methods that can solve the above-mentioned issue. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate optimising Sl acquisition for NR devices.

In one aspect, the techniques disclosed herein provide a communication apparatus. For example, the communication apparatus can be a subscriber UE, which may be a normal (non-RedCap or Rel-15/16/17 onwards) UE, a RedCap UE or other similar types of UE. The communication apparatus comprises a receiver, which in operation, receives control information relating to a first period and/or a second period; and circuitry, which in operation, acquires system information (Sl) in the first period if a first condition is met, or acquires the Sl in the second period if a second condition is met.

In another aspect, the techniques disclosed herein provide a communication apparatus. For example, the communication apparatus can be a subscriber UE, which may be a normal (non-RedCap or Rel-15/16/17 onwards) UE, a RedCap UE or other similar types of UE. The communication apparatus comprises a receiver, which in operation, receives control information indicating an explicit indication or a validity duration or timer; and circuitry, which in operation, skips acquisition of at least a part of Sl based on the control information.

In another aspect, the techniques disclosed herein provide a communication apparatus. For example, the communication apparatus can be a base station or gNodeB (gNB) which comprises circuitry, which in operation, generates control information indicating a first period and/or second period; and a transmitter, which in operation, transmits the control information to a communication apparatus.

In another aspect, the techniques disclosed herein provide a communication apparatus. For example, the communication apparatus can be a base station or gNodeB (gNB) which comprises circuitry, which in operation, generates control information indicating an explicit indication or a validity duration or timer for skipping acquisition of at least a part of Sl; and a transmitter, which in operation, transmits the control information to a communication apparatus.

In another aspect, the techniques disclosed herein provide a communication method. The communication method comprises receiving control information indicating a first period and/or second period; and acquiring Sl based on the first period if a first condition is met, or acquiring Sl based on the second period if a second condition is met.

In another aspect, the techniques disclosed herein provide a communication method. The communication method comprises receiving control information indicating an explicit indication or a validity duration or timer for skipping acquisition of at least a part of Sl; and skipping acquisition of the at least a part of the Sl based on the control information.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 shows an exemplary architecture for a 3GPP NR system.

FIG. 2 is a schematic drawing which shows functional split between NG-RAN and 5GC.

FIG. 3 is a sequence diagram for RRC connection setup/reconfiguration procedures.

FIG. 4 is a schematic drawing showing usage scenarios of Enhanced mobile broadband (eMBB), Massive Machine Type Communications (mMTC) and Ultra Reliable and Low Latency Communications (URLLC).

FIG. 5 is a block diagram showing an exemplary 5G system architecture for a non-roaming scenario.

FIG. 6 shows an example mapping scheme of Sl,

FIG. 7 shows an example illustration of Sl provision.

FIG. 8 shows an example illustration of Sl acquisition within a modification period.

FIG. 9 shows an example illustration of Sl acquisition across a modification period boundary.

FIG. 10 shows an example illustration of an extended modification period for RedCap UEs in accordance with various embodiments.

FIG. 11 shows an example illustration of how a spare bit in master information block (MlB) is used to indicate an extended modification period in accordance with various embodiments.

FIG. 12 shows an example flowchart for UE operation on the MIB spare bit of FIG. 11 in accordance with various embodiments.

FIG. 13 shows an example illustration of how a new indication in MIB is used to indicate an extended modification period in accordance with various embodiments.

FIG. 14 shows an example illustration of how a new indication in MIB is used to indicate that acquisition of SIB1 (system information block type 1) can be skipped in accordance with various embodiments

FIG. 15 shows an example flowchart for UE operation on the MIB new indication of FIG. 14 in accordance with various embodiments.

FIG. 16 shows a flow diagram of a communication method for optimising Sl acquisition for RedCap NR devices by implementing an extended modification period in accordance with various embodiments.

FIG. 17 shows a flow diagram of a communication method for optimising Sl acquisition for NR devices by indicating whether Sl acquisition can be skipped in accordance with various embodiments.

FIG. 18 shows a schematic example of a communication apparatus that can be used for optimising SI acquisition for NR devices in accordance with various embodiments.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Some embodiments of the present disclosure will be described, by way of example only, with reference to the drawings. Like reference numerals and characters in the drawings refer to like elements or equivalents.

### 5G NR System Architecture and Protocol Stacks

3GPP has been working at the next release for the 5^{th} generation cellular technology, simply called 5G, including the development of a new radio access technology (NR) operating in frequencies ranging up to 100 GHz. The first version of the 5G standard was completed at the end of 2017, which allows proceeding to 5G NR standard-compliant trials and commercial deployments of smartphones.

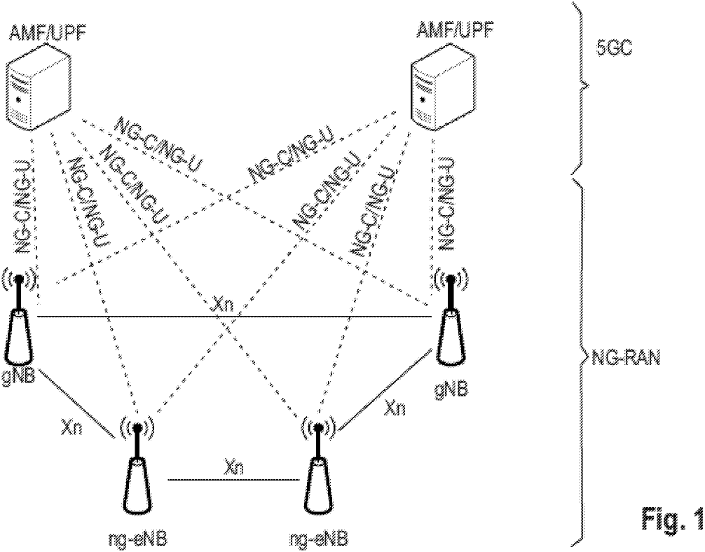

Among other things, the overall system architecture assumes an NG-RAN (Next Generation — Radio Access Network) that comprises gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g. a particular core entity performing the AMF) by means of the NG--C interface and to the UPF (User Plane Function) (e.g. a particular core entity performing the UPF) by means of the NG-U interface. The NG-RAN architecture is illustrated in FIG. 1 (see e.g. 3GPP TS 38.300 v15.6.0, section 4).

The user plane protocol stack for NR (see e.g. 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g. sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300.

For instance, the Medium-Access-Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are PRACH (Physical Random Access Channel), PUSCH (Physical Uplink Shared Channel) and PUCCH (Physical Uplink Control Channel) for uplink and PDSCH (Physical Downlink Shared Channel), PDCCH (Physical Downlink Control Channel) and PBCH (Physical Broadcast Channel) for downlink.

Use cases / deployment scenarios for NR could include enhanced mobile broadband (eMBB), ultra-reliable low-latency communications (URLLC), massive machine type communication (mMTG), which have diverse requirements in terms of data rates, latency, and coverage. For example, eMBB is expected to support peak data rates (20 Gbps for downlink and 10 Gbps for uplink) and user-experienced data rates in the order of three times what is offered by IMT--Advanced. On the other hand, in case of URLLC, the tighter requirements are put on ultra-low latency (0.5 ms for UL and DL each for user plane latency) and high reliability (1-10⁵ within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g. subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz... are being considered at the moment. The symbol duration Tᵤ and the subcarrier spacing Δf are directly related through the formula Δf = 1/Tᵤ. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v15.6.0).

### 5G NR Functional Split Between NG-RAN and 5GC

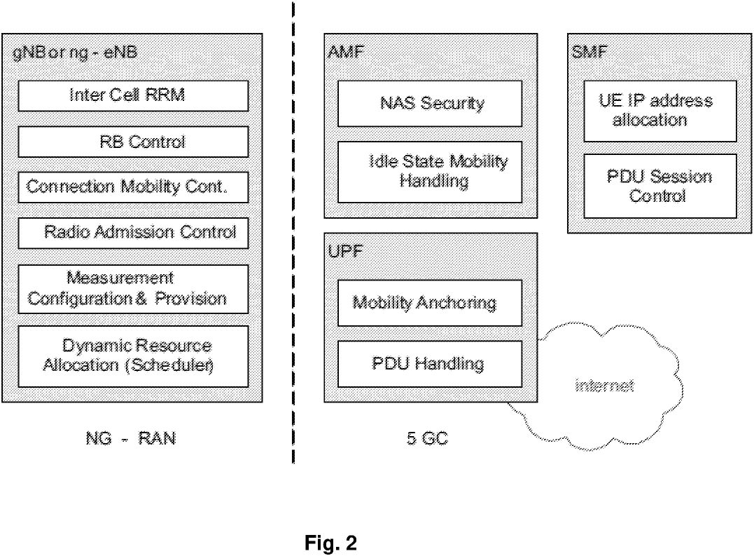

FIG. 2 illustrates functional split between NG-RAN and 5GC. NG-RAN logical node is a gNB or ng-eNB. The 5GC has logical nodes AMF, UPF and SMF.

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signalling termination;
NAS signalling security;
Access Stratum, AS, Security control;
Inter Core Network, CN, node signalling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-horned PDU session;
QoS handling for user plane, e.g. packet filtering, gating, UL/DL rate enforcement;
Uplink Traffic verification (SDF to QoS flow mapping);
Downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

### RRC Connection Setup and Reconfiguration Procedures

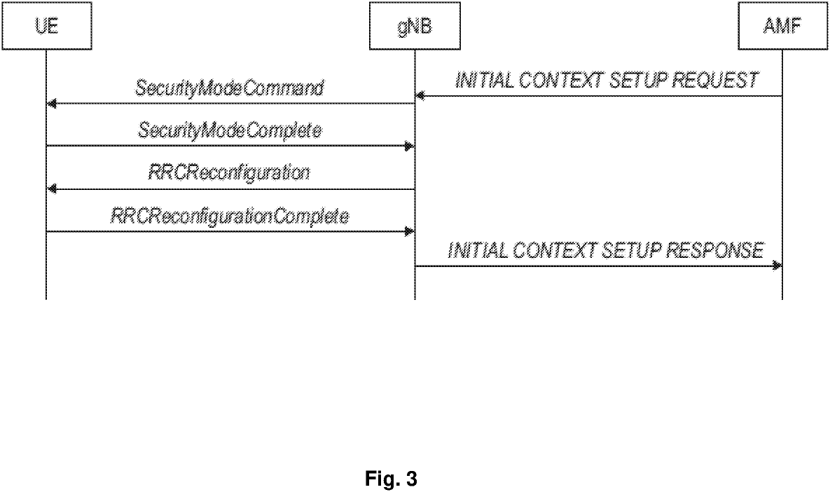

FIG. 3 illustrates some interactions between a UE, gNB, and AMF (an 5GC entity) in the context of a transition of the UE from RRC_IDLE to RRC_CONNECTED for the NAS part (see TS 38.300 v15.6.0). RRC is a higher layer signaling (protocol) used for UE and gNB configuration. In particular, this transition involves that the AMF prepares the UE context data (including e.g. PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signalling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

In the present disclosure, thus, an entity (for example AMF, SMF, etc.) of a 5th Generation Core (5GC) is provided that comprises control circuitry which, in operation, establishes a Next Generation (NG) connection with a gNodeB, and a transmitter which, in operation, transmits an initial context setup message, via the NG connection, to the gNodeB to cause a signaling radio bearer setup between the gNodeB and a user equipment (UE). In particular, the gNodeB transmits a Radio Resource Control, RRC, signaling containing a resource allocation configuration information element to the UE via the signaling radio bearer. The UE then performs an uplink transmission or a downlink reception based on the resource allocation configuration.

### Usage Scenarios of IMT for 2020 and Beyond

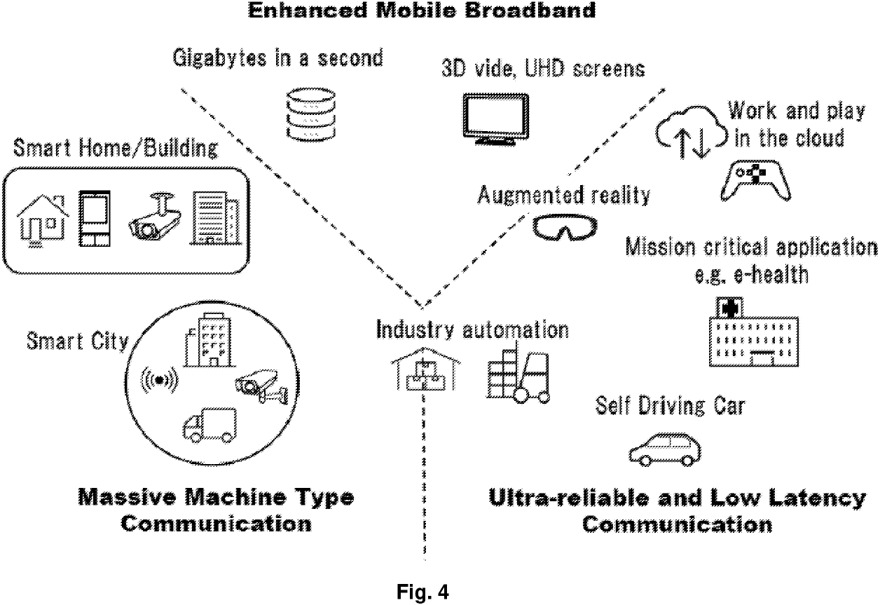

FIG. 4 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications. FIG. 4 illustrates some examples of envisioned usage scenarios for IMT for 2020 and beyond (see e.g. ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E-5 for a packet size of 32 bytes with a user plane latency of 1 ms.

From the physical layer perspective, reliability can be improved in a number of possible ways. The current scope for improving the reliability involves defining separate CQl tables for URLLC, more compact downlink control information (DCI) formats, repetition of PDCCH, etc. However, the scope may widen for achieving ultra-reliability as the NR becomes more stable and developed (for NR URLLC key requirements). Particular use cases of NR URLLC in Rel- 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non-slot-based scheduling with flexible mapping, grant free (configured grant) uplink, slot-level repetition for data channels, and downlink pre--emption. Pre-emption means that a transmission for which resources have already been allocated is stopped, and the already allocated resources are used for another transmission that has been requested later, but has lower latency / higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQl/MCS tables for the target BLER of 1 E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10⁻⁶ level), higher availability, packet sizes of up to 256 bytes, time synchronization down to the order of a few µs where the value can be one or a few µs depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini--slot” refers to a Transmission Time Interval (TTI) including a smaller number of symbols than a slot (a slot comprising fourteen symbols).

### QoS Control

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g. as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

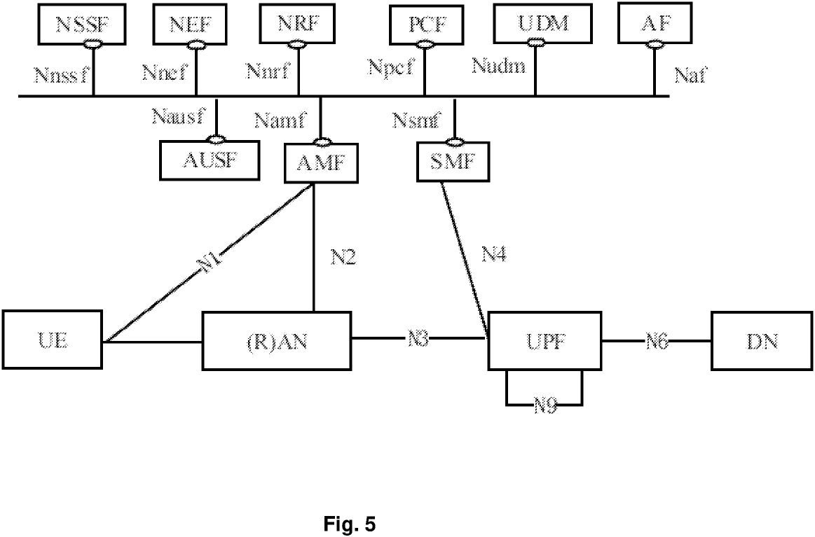

FIG. 5 illustrates a 5G NR non-roaming reference architecture (see TS 23.501 v16.1.0, section 4.23). An Application Function (AF), e.g. an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g. QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture, namely Network Slice Selection Function (NSSF), Network Repository Function (NRF), Unified Data Management (UDM), Authentication Server Function (AUSF), Access and Mobility Management Function (AMF), Session Management Function (SMF), and Data Network (DN), e.g. operator services, Internet access or 3rd party services. All of or a part of the core network functions and the application services may be deployed and running on cloud computing environments.

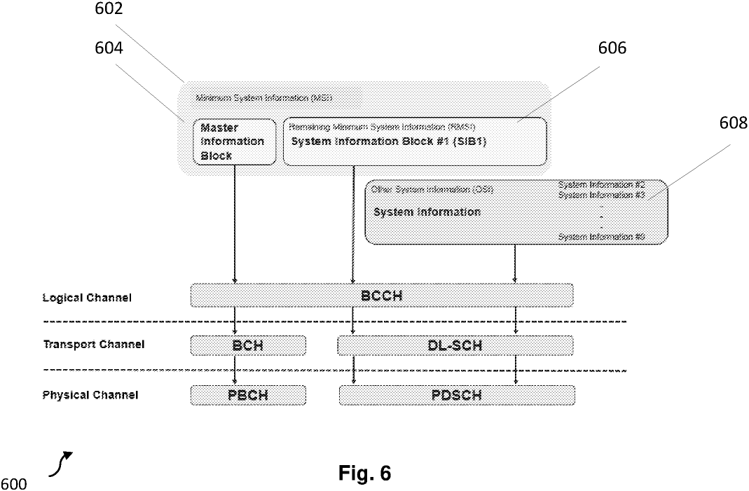

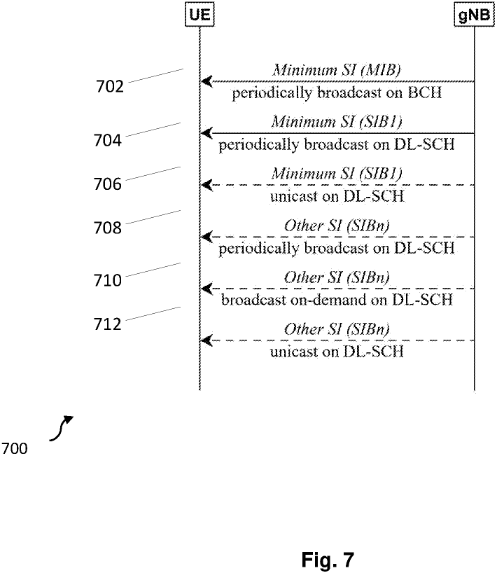

System information (SI) can be divided into three categories as shown in FIG. 6 and FIG. 7. Minimum system information (MSI) 602 is comprised of MIB 604 and SIB1 606. MIB 604 includes parameters that are needed to acquire SIB1 606 from the cell. As shown in ref 702 of FIG. 7, MIB is periodically broadcasted on broadcast channel (BCH) from gNB to UEs.

For the remaining MSI, SIB1 606 includes information regarding the availability and scheduling information (e.g. mapping of system information blocks (SIBs) to SI message, periodicity, SI-window size) of other SIBs i.e. in other system information (OSI) 608. SIB1 606 is periodically broadcasted on DL-SCH (see ref 704 of FIG. 7) or sent in a dedicated manner on DL-SCH (see ref 706 of FIG. 7) in RRC₋₋₋ CONNECTED.

Other system information (OSI) 606 comprises SIB2 - SIB9. As shown in refs 706, They can either be periodically broadcasted on DL-SCH as shown in ref 708 of FIG. 7, broadcasted on-demand on DL-SCH (i.e. upon request from UEs in RRC _IDLE/INACTIVE) as shown in ref 710 of FIG. 7, or sent in a dedicated manner on DL-SCH to UEs in RRC_CONNECTED as shown in ref 712 of FIG. 7.

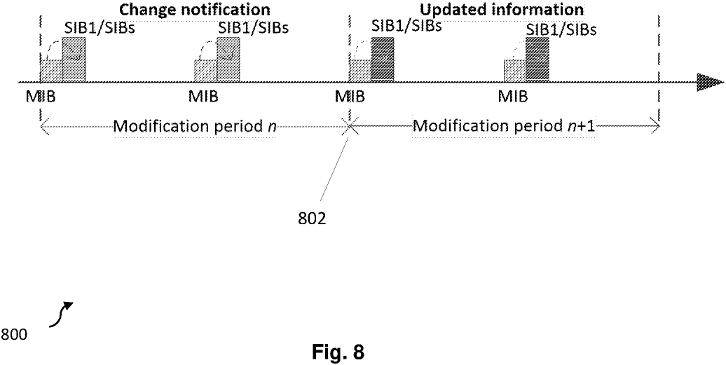

SI includes MlB and a number of SIBs, where MIB includes parameters that are needed to acquire SIB1 from the cell, SIB1 includes information regarding the availability and scheduling of other SIBs, and SIBs other than SIB1 are carried in Systeminformation messages. In Rel-15, the content of SI may only be changed after a modification period. Within the modification period, the same content of SI may be transmitted a number of times. A modification period boundary is defined by system frame number (SFN) value, i.e., SFN mod m = 0, where m is the number of radio frames (rfs) comprising the modification period. When gNB changes (some of the) SI, it first notifies the UEs about this change in a modification period. In next modification period, an updated SI is transmitted. For example, FIG. 8 shows that, upon receiving a change notification, a UE acquires an updated SI including MlB, SIB1 and/or SIBs from the start of the next modification period n + 1 i.e. from ref 802 onwards.

In Rel-15, the modification period is configured by system information specified in BCCH-Config of SIB1. It can be expressed in number of radio frames as m = modificationPeriodCoeff *defaut PagingCycle. In RP-193238, a study item relating to potential UE complexity reduction features for RedCap was discussed, such as reducing the number of UE Rx/Tx antennas, UE bandwith reduction and other similar features.

A first observation is that RedCap UEs such as wireless sensors can work at low SNR region in some cases. A second observation is that RedCap UEs may experience longer SI acquisition time than that of non-RedCap UEs.

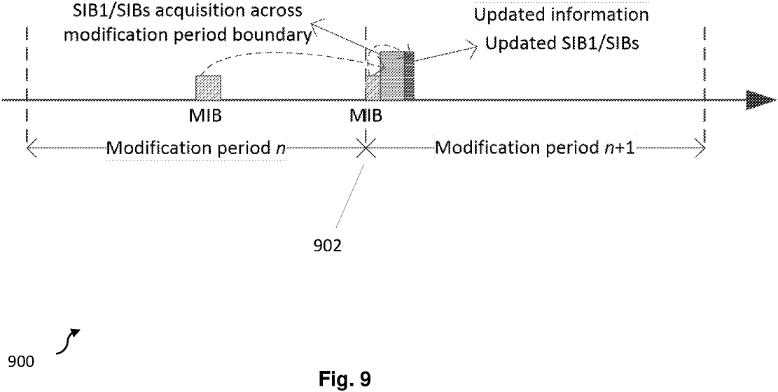

A RedCap UE can take a longer time than the configured modification period to acquire some of SIBs (SIB1 and/or other SIBs) in low SNR region, hence it can have difficulties to decode SI across the modification period boundary. As shown in FIG. 9, the acquisition of these SIBs across this boundary (indicated by ref 902) can impact on SIB1 and/or other SIBs reading in the subsequent modification period.

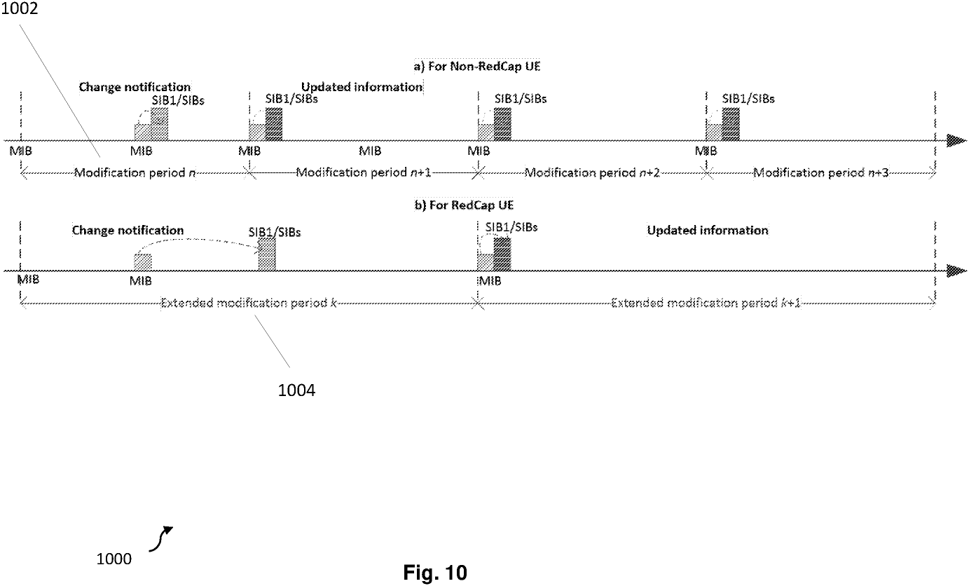

According to various embodiments, a second period i.e. an extended modification period is proposed for RedCap UEs in addition to a first period i.e. a modification period. The extended modification period for RedCap UEs includes a larger number of radio frames as compared with that of the modification period for non-RedCap (legacy/normal) UEs specified in Rel-15/16 Specs. The extended modification period for RedCap UEs may include a same number of radio frames as the modification period for non-RedCap (legacy/normal) UEs specified in Rel-15/16 Specs. For example, referring to FIG. 10, the extended modification period 1004 for RedCap UEs is double the length of the modification period 1002 for non-RedCap UEs, or the number of radio frames in the extended modification period 1004 for RedCap UEs is double amount of that in the modification period 1002 for non-RedCap UEs. It will be appreciated that the extended modification period can also be of another value larger than the length of the modification period, instead being double the length of the modification period as shown in FIG. 10. Advantageously, this allows RedCap UE to have more time to acquire system information. System overhead of RedCap UE can be configured to be the same as or to be smaller than that of non-RedCap UE during the duration of time to acquire the system information.

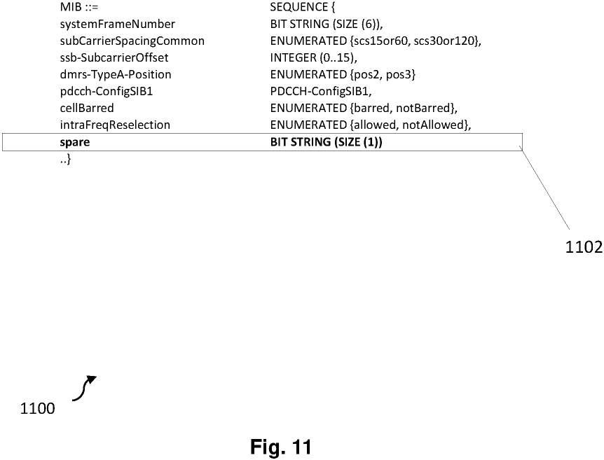

According to various embodiments, the extended modification period for RedCap UEs may be indicated by reusing at least a spare bit in MIB. For example, referring to MIB IE 1100 of FIG. 11, if spare bit 1102 in MIB is indicated as 1, it corresponds to the extended modification period for RedCap UEs. Otherwise, it indicates that there is no extension of the modification period. The extended modification period for RedCap UEs may either be a multiple of the modification period for non--RedCap (legacy/normal) UEs specified in Rel-15/16 Specs or a different value which is provided in the specifications. A benefit of reusing a spare bit in MIB for indication of extended modification period is that there is no impact on specifications as non-RedCap UEs still use the modification period specified in Rel-15/16.

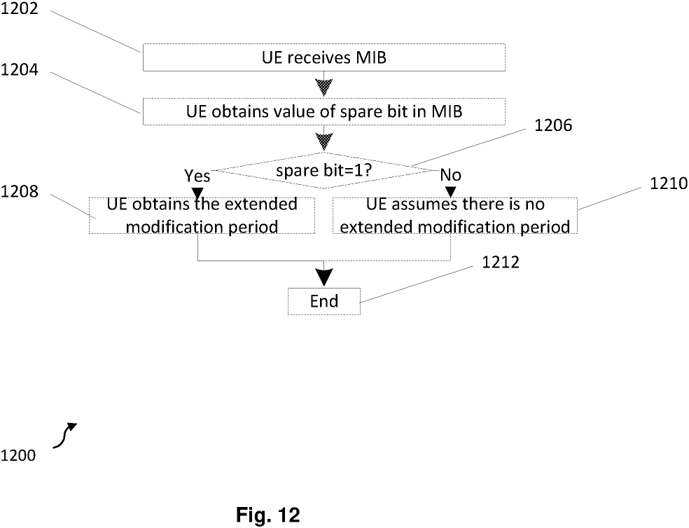

FIG. 12 shows an example flowchart 1200 for UE operation on the MIB spare bit 1102 of FIG. 11 in accordance with various embodiments. At step 1202, a RedCap UE receives the MIB IE 1100 of FIG. 11. At step 1204, the RedCap UE obtains value of the spare bit in the MIB. At step 1206, it is determined whether the spare bit has a value of 1. If it is determined to be so, the process proceeds to step 1208 where the UE obtains the extended modification period, and the process ends at step 1212. Otherwise, the process proceeds to 1210 where the RedCap UE assumes that there is no extended modification period, and then the process ends at step 1212. Thus, in summary, upon receiving the MIB, the RedCap UE defines whether the spare bit is set as 0 or 1. If it is set to 1, the RedCap UE obtains the extended modification period. Otherwise, the RedCap UE assumes that there is no extension of the modification period and uses the normal modification period instead. It will be appreciated that the non-RedCap UE will still use the normal modification period even if it receives the MIB with spare bit of value 1.

In an example, a value of the extended modification period for RedCap UEs may be defined based on the longest duration of time for SI acquisition from multiple SI acquisition time required from different RedCap use cases including wireless sensors, video surveillance, and wearables. In another example, the value of the extended modification period for RedCap UEs may defined as a multiple of 40.96 s, where 40.96 s is the maximum of modification period in current Rel-15 Specs.

In another example, a maximum value of the extended modification period is larger than a maximum value of the modification period for non-RedCap UE.

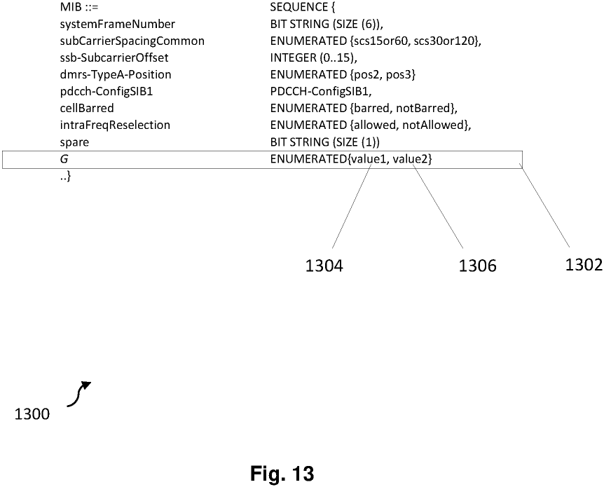

According to various embodiments, instead of reusing a spare bit in MIB, the extended modification period for RedCap UEs may be indicated by using a new indication in MIB. For example, referring to example MIB information element 1300 of FIG. 13, new indication G 1302 is additionally proposed in MlB to indicate the extended modification period for RedCap UEs, where value1 1304 and value2 1306 correspond to 40.96 s and 81.92 s, respectively. It will be appreciated that this is only an example and there can be various other possibilities in term of values for G which can be configured.

According to various embodiments, the extended modification period for RedCap may be indicated by one of the SIBs. For example, a new indication (such as one similar to new indication G 1302 in FIG. 13) is additionally proposed in SIB2 to indicate the extended modification period for RedCap UEs. Alternatively or additionally, the extended modification period for RedCap may be indicated by a dedicated higher layer signalling. For example, a new indication (such as one similar to new indication G 1302 in FIG. 13) is additionally proposed in a dedicated RRC message to indicate the extended modification period for RedCap UEs.

According to various embodiments, within the extended modification period 1004 as shown in FIG. 10, when a RedCap UE is able to successfully acquire SIB1/SIBs in a modification period (e.g., a modification period corresponds to a period n 1002 of non-RedCap UEs shown in FIG. 10), it does not decode SIB1/SIBs transmitted in remaining durations (e.g. modification period of period n+ 1 of FIG. 10). Alternatively or additionally, a RedCap UE may not decode SIB1/SIBs from some repetitions of SIB1/SIBs in a modification period (e.g., a second and a forth repetition of SIB1/SIBs in a modification period of period n of FIG. 10).

According to various embodiments, a same content of the SI is mapped over a first period (e.g. a modification period) for a first condition (e.g. the UE being a non-RedCap UE) and is mapped over a second period (e.g. an extended modification period) for a second condition (e.g. the UE being a RedCap UE).

The first condition and the second condition are not limited to a non-RedCap UE and a RedCap UE. In some cases, whether the second condition is met may be indicated by an explicit indication, a validity duration or a timer.

According to various embodiments, an interval to which a same content of the SI may be mapped for the second condition may be equal to or larger than that for the first condition.

According to various embodiments, a number of repetitions of the SI in the second period may be same as or smaller than that in the first period.

According to various embodiments, wherein an interval to acquire the SI in the second condition may be equal to or longer than that in the first condition.

According to various embodiments, wherein an interval to map the SI may be same between the first condition and the second condition, and a part of the SI with a certain interval may be acquired in the second condition.

The extended modification period boundary for RedCap UEs can be defined by an equation as (A ∗ 1024 + SFN) mod m = 0, where A is timer at the next level to SFN, instead of SFN mod m= 0 specified in the Rel-15/16 specifications. A value of the timer ranges between 0 and A. The value of the timer increases by 1 when SFN reaches 1023. When a value of timer hits A, it goes back to 0. For example, herein, it is assumed that m is set as 512 radio frames (rfs), which is equivalent as 5120 ms, and A is set as 1, the actual number of radio frames in a modification period (defined from SFN mod m = 0) is 512, while the actual number of radio frames in the extended modification period (defined from ((A ∗ 1024 + SFN) mod m = 0) is 1536 (rfs). This is because, when A =1 is configured, the value of timer ranges from 0 to 1. The value of the timer increases by 1 when SFN reaches 1023: Step 1: Value of timer =0, SFN is increased from 0 to 1023, equation skips value 512, 1024 rfs; Step 2: As SFN hits 1023, value of timer is increased 1, equation gets 1536 rfs. As the value of timer hits 1, it goes back to 0. For this scenario, the value of A for RedCap UEs may be indicated by reusing at least a spare bit or new parameter in a MIB, a SIB, or a dedicated higher-layer signalling. The extended modification period boundary for RedCap UEs is not less than the modification period boundary for non-RedCap (legacy/normal) UEs.

In addition, the actual extended modification period for RedCap UEs can be expressed in number of rfs as m = modificationPeriodCoeff^{∗}defautPagingCycle. It is possible that gNB can additionally configure the extended values of modificationPeriodCoeff and/or defautPagingCycle for RedCap UEs. For example, herein, a paging cycle in the defautPagingCycle information element (IE) is additionally configured as rf512, rf1024 (highlighted in bold font), etc, as follows:

| | |
|---|---|
| defaultPagingCycle | PagingCycle, |
| PagingCycle ::= | ENUMERATED {rf32, rf64, rf128, rf256, rf512, rf1024}, |

where rf512 and rf1024 correspond to values of 512 and 1024 radio frames, respectively.

The above-mentioned solutions allow a UE to prevent decoding SI across the modification period boundary and allow a UE to have more time to acquire SI (more actions from UE side). Also, in the above-mentioned solutions, within an extended modification, gNB may prepare and transit SI (periodically MlB/SIB1, or other SIBs) or paging message a number of times, etc. Further, in the above-mentioned solutions, the UE may define extended modification, then it may acquire MlB/SIB1, other SIBs or monitors for SI change indication in any paging occasion at least once per the extended modification period, the UE can have more time to keep trying more attempts to decode the SI until the UE decodes SI correctly, etc. Further, the above-mentioned solutions can applicable for initial access (e.g. upon power on), upon cell-reselection, return from out of coverage, RRC re-establishment, after reconfiguration with sync completion, after entering the network from another RAT, upon receiving an indication that the system information has changed, upon receiving a PWS notification; and whenever the UE does not have a valid version of a stored SIB.

There are various situations in which a UE may be required to acquire SI, such as for initial access, upon cell-reselection, return from out of coverage, or RRC re-establishment. However, the Sl rarely changes in a cell. This acquisition of SI by the UE might just be unnecessary if SI has not been changed, i.e., re-acquisition of SI. It is therefore reasonable to allow UE to skip SI acquisition in these cases, such that the UE does not need to acquire SI (for example, SIB1) at low SNR region, since the UE can simply rely on a stored SIB1 i.e. a SIB1 which is previously acquired by the UE and then stored in the UE, and is still valid since SI is unchanged. Advantageously, this reduces efforts of measurement and acquisition of SIB1 from UEs which result in power saving.

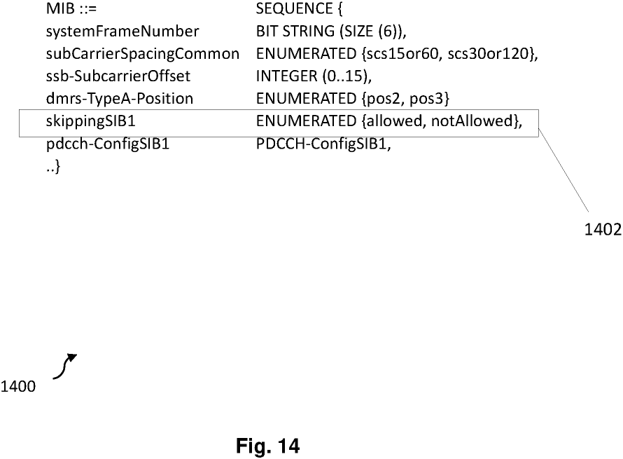

Acquisition of SIB1 can be skipped based on certain conditions. The conditions could be based on one or a combination of (1) an explicit indication or (2) a validity duration or a timer. The explicit indication may be signalled by either reusing at least a spare bit or adding a new indication in MIB. For example, referring to MlB IE 1400 of FIG. 14, a new indication skippingSIB1 1402 is added in MIB to indicate whether skipping SIB1 acquisition is allowed or not.

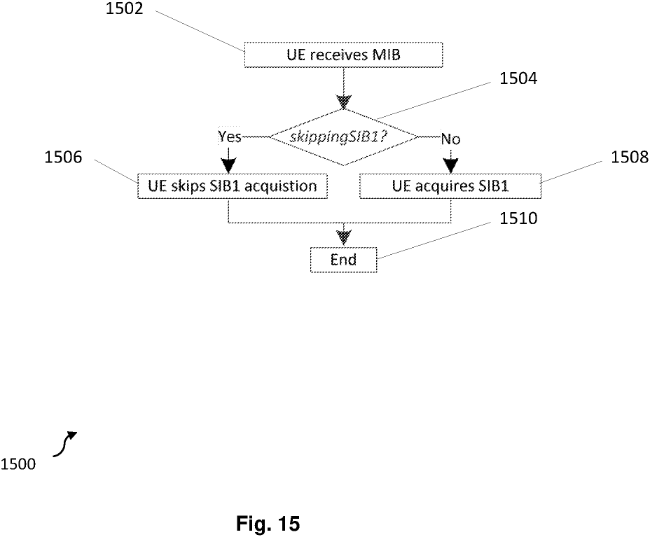

FIG. 15 shows an example flowchart 1500 for UE operation on the MIB new indication skippingSIB1 1402 of FIG. 14 in accordance with various embodiments. At step 1502, a RedCap UE receives the MIB IE 1400 of FIG. 14. At step 1504, it is determined whether the skippingSIB1 1402 is configured (i.e. indicating to skip acquisition of SIB1) or not. If it is determined that the skippingSIB1 1402 is configured, the process proceeds to step 1506 where the UE skips SIB1 acquisition, and the process ends at step 1510. Otherwise, the process proceeds to 1508 where the UE acquires SIB1, and then the process ends at step 1510. Thus, in summary, upon receiving the MIB, the UE checks whether the explicit indication skippingSIB1 1402 is configured or not. If configured, the UE assumes that SIB1 has not been changed, so that it will skip SIB1 reading as it has a valid version of a stored SIB1.

According to various embodiments, instead of indicating by MIB, the explicit indication may be signalled by adding a new indication in one of the SIBs of the serving cell. In addition, instead of indicating by MIB, the explicit indication may be signalled by adding a new indication in an area specific SIB. The area specific SIB is applicable within an area consisting of one or several cells, e.g., systemInformationArealD. Moreover, instead of indicating by MIB, the explicit indication may be signalled by a dedicated high-layer signalling. According to various embodiments, acquisition of SIB1 can be skipped based on a validity duration or a timer configuration of SIB1. The validity duration or timer configuration may be indicated by at least a spare bit or adding a new indication in MIB. While the validity duration or timer is valid, the UE would assume that there is no change of SIB1, hence it skips the re-acquisition of SIB1 as it has a valid version of a stored SIB1. The validity duration or timer of SIB1 may be defined as L seconds, minutes, or hours. The validity duration or timer of SIB1 can be defined as a multiple of 3 hours. The UE shall delete a stored version of SIB1 after a duration of L from the moment it was successfully confirmed as valid, instead of 3 hours in Rel-15/16 Specs (i.e., UE behaviour changes). In the other words, the UE shall delete the stored version of SIB1 after the validity duration or timer has lapsed. Moreover, the timer can be configured based on demand basic. Particularly, if timer is not configured or configured as a symbolic value such as infinity or zero, the acquisition of SIB1 is not allowed to be skipped, if timer is configured as a predefined value, the acquisition of SIB1 can be skipped. Furthermore, the acquisition of SIB1 may also be skipped based on the UE capability. For example, if the acquisition time of SIB1 is determined to be longer than the maximum length in time for acquiring SIB1 based on UE capability, the acquisition of SIB1 is skipped.

According to various embodiments, instead of skipping the acquisition of SIB1, the acquisition of at least a part of SIB1 (i.e. a part of information specified in SIB1) can be skipped based on certain conditions. These conditions could be based on one or a combination of (1) an explicit indication, or (2) a validity duration or a timer. It will be appreciated that the various embodiments and examples for skipping acquisition of SIB1 as discussed above are similarly applicable here. Advantageously, this enables a UE to flexibly keep up--to--date regarding a change of a part of SIB1, if any. This is because, based on the certain indication, if there is any small change in SIB1, the UE only updates this change and skips the acquisition of the remaining information in SIB1,

According to various embodiments, instead of skipping the acquisition of SIB1, the acquisition of one or more SIBs other than SIB1 can be skipped based on certain conditions. These conditions could be based on one or a combination of (1) an explicit indication, or (2) a validity duration or a timer. It will be appreciated that the various embodiments and examples for skipping acquisition of SIB1 as discussed above are similarly applicable here. A benefit of this implementation is that efforts for measurement and acquisition of SIB(s) from UEs are reduced which result in power saving.

According to various embodiments, instead of skipping the acquisition of SIB1, the acquisition of MIB can be skipped based on certain conditions. These conditions could be based on one or a combination of (1) an explicit indication when the UE has a valid version of a stored MIB, or (2) a validity duration or a timer. The explicit indication or validity duration or timer is signalled by a dedicated higher-layer signalling. It will be appreciated that the various embodiments and examples for skipping acquisition of SIB1 as discussed above are similarly applicable here. A benefit of this implementation is that efforts for acquisition of MIB from UEs are reduced which result in power saving.

Depending on network conditions and/or UE capabilities, one or multiple solutions and alternatives as discussed above can be applied. These solutions and alternatives are applicable for different types of UEs. For example, Type 1 may correspond to non--RedCap UEs, while Type 2 may correspond to RedCap UEs.

It will also be appreciated that Non-RedCap UE and RedCap UE can be replaced with a first UE and a second UE in the disclosure.

Depending on the various embodiments and examples as discussed above, the extended modification period for RedCap UEs may be indicated by a RedCap UE-specific MlB, a RedCap UE-specific SIB1, and/or one or more RedCap UE--specific SiBs.

Depending on the various embodiments and examples as discussed above, the explicit indication may be indicated by a RedCap UE-specific MIB, a RedCap UE-specific SIB1, one or more RedCap UE-specific SiBs, and/or a downlink control information (DCI).

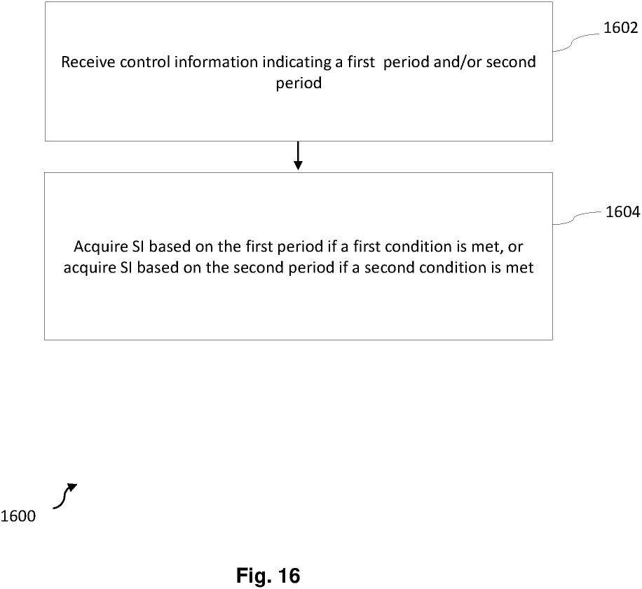

FIG. 16 shows a flow diagram 1600 illustrating a communication method according to various embodiments. In step 1602, control information indicating a first period and/or second period is received. In step 1604, SI is acquired based on the first period if a first condition is met, or SI is acquired based on the second period if a second condition is met.

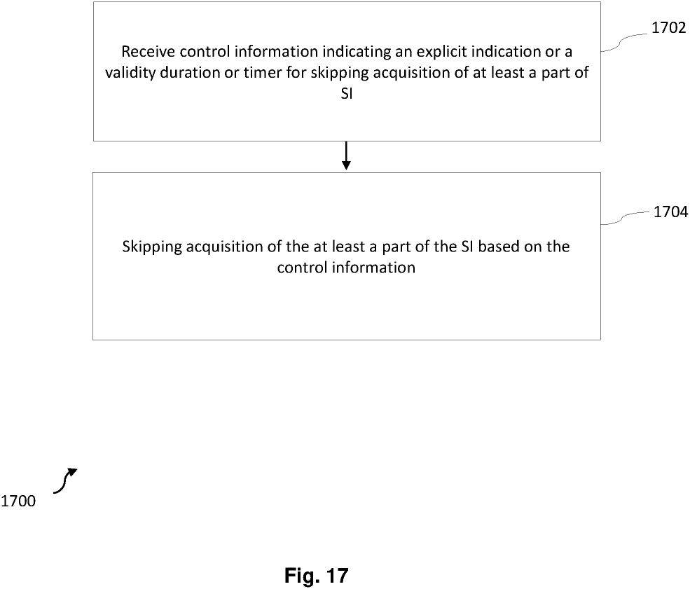

FIG. 17 shows a flow diagram 1700 illustrating a communication method according to various embodiments. In step 1702, control information indicating an explicit indication or a validity duration or timer for skipping acquisition of at least a part of SI is received. In step 1704, acquisition of the at least a part of the SI is skipped based on the control information.

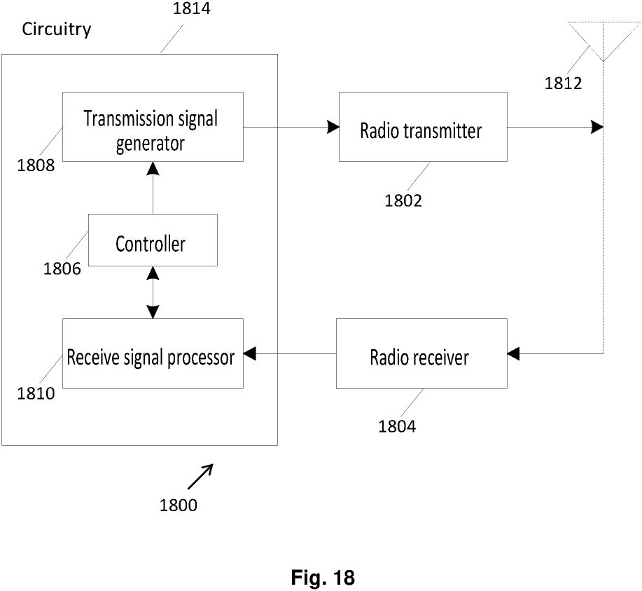

FIG. 18 shows a schematic, partially sectioned view of the communication apparatus 1800 that can be implemented for optimising SI acquisition for NR devices in accordance with the various embodiments. The communication apparatus 1800 may be implemented as a base station, gNB or a normal (non--RedCap or Rel-15/16/17 onwards) UE, a RedCap UE or other similar types of UE according to various embodiments.

Various functions and operations of the communication apparatus 1800 are arranged into layers in accordance with a hierarchical model. In the model, lower layers report to higher layers and receive instructions therefrom in accordance with 3GPP specifications. For the sake of simplicity, details of the hierarchical model are not discussed in the present disclosure.

As shown in FIG. 18, the communication apparatus 1800 may include circuitry 1814, at least one radio transmitter 1802, at least one radio receiver 1804 and multiple antennas 1812 (for the sake of simplicity, only one antenna is depicted in FIG. 18 for illustration purposes). The circuitry 1814 may include at least one controller 1806 for use in software and hardware aided execution of tasks it is designed to perform, including control of communications with one or more other communication apparatuses in a MIMO wireless network. The at least one controller 1806 may control at least one transmission signal generator 1808 for generating control information, IEs and/or RRC-Reconfig messages to be sent through the at least one radio transmitter 1802 to one or more other communication apparatuses and at least one receive signal processor 1810 for processing said control information, IEs and/or RRC-Reconfig messages received through the at least one radio receiver 1804 from the one or more other communication apparatuses. The at least one transmission signal generator 1808 and the at least one receive signal processor 1810 may be stand-alone modules of the communication apparatus 1800 that communicate with the at least one controller 1806 for the above-mentioned functions, as shown in FIG. 18. Alternatively, the at least one transmission signal generator 1808 and the at least one receive signal processor 1810 may be included in the at least one controller 1806. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 1802, at least one radio receiver 1804, and at least one antenna 1812 may be controlled by the at least one controller 1806.

In the embodiment shown in FIG. 18, the at least one radio receiver 1804, together with the at least one receive signal processor 1810, forms a receiver of the communication apparatus 1800. The receiver of the communication apparatus 1800, when in operation, provides functions required for optimising SI acquisition for RedCap N R devices.

The communication apparatus 1800, when in operation, provides functions required for optimising SI acquisition for NR devices. For example, the communication apparatus 1800 may be a communication apparatus, and the receiver 1804 may, in operation, receive control information relating to a first period and/or a second period. The circuitry 1814 may, in operation, acquire system information (SI) in the first period if a first condition is met, or acquires the SI in the second period if a second condition is met.

The first period may be a modification period and is not longer than the second period. A same content of the SI may be mapped over the second period for the second condition. An interval to which a same content of the SI is mapped for the second condition may be equal to or larger than that for the first condition. A number of repetition of the SI in the second period is same as or is smaller than that in the first period.

The first condition may be that the communication apparatus is a first type of user equipment (UE) and the second condition may be that the communication apparatus is a second type of UE. The first type of UE may be a non-Reduced Capability (RedCap) UE and the second type of UE may be a RedCap UE. A boundary of the first period may not be greater than a boundary of the second period. The second period may be a multiple of the first period. A maximum value of the second period may be larger than a maximum value of the first period. The second period may be a multiple of 40.96 s, wherein 40.96 s is a maximum duration of the first period. The second period may be defined based on a longest duration of time required for RedCap UEs to acquire SI. The second period may be indicated by at least a spare bit or a new parameter in a master information block (MlB), a system information block (SIB), or a dedicated higher layer signalling.

The circuitry 1814 may be further configured to acquire the SI in a certain time duration within the second period if the second condition is met. An interval to acquire the SI in the second condition may be longer than that in the first condition. An interval to map the SI may be same between the first condition and the second condition, wherein the circuitry 1814 may be further configured to acquire a part of the SI within the second period if the second condition is met. The circuitry 1814 may be further configured to not acquire some repetitions of the SI that are transmitted in a certain time duration within the second period if the second condition is met. Whether the second condition is met may be determined by an explicit indication, a validity duration or a timer, such that the circuitry 1814 may be configured to skip acquisition of at least a part of the SI when the explicit indication, validity duration or timer indicates that the SI is still valid. The control information may further indicate an explicit indication or a validity duration or timer, wherein the circuitry 1814 may be further configured to skip acquisition of at least a part of the SI based on the control information.

The communication apparatus 1800, when in operation, provides functions required for optimising SI acquisition for NR devices. For example, the communication apparatus 1800 may be a communication apparatus, and the receiver 1804 may, in operation, receive control information indicating an explicit indication or a validity duration or timer. The circuitry 1814 may, in operation, skip acquisition of at least a part of SI based on the control information.

The at least a part of the SI may be a MIB, or a system information block type 1 (SIB1), or one or more SIBs other than SIB1. The validity duration or the timer may be defined as L seconds, minutes, or hours. The validity duration or timer may be a multiple of 3 hours. The circuitry 1814 may be further configured to delete a stored version of Sl after the validity duration or timer has lapsed. The circuitry 1814 may be further configured to not skip acquisition of at least a part of the SI if the validity duration or timer is not configured, and may skip acquisition of at least a part of the SI if the validity duration or timer is configured as a predefined value. The circuitry 1814 may skip acquisition of at least a part of SI based on the control information if it is further configured to trigger cell-reselection, return from out of coverage, or RRC re-establishment procedures. The circuitry may be further configured to skip acquisition of at least a part of contents of SIB1 based on the control information. The explicit indication may be a maximum time duration available for acquiring the SI, wherein the circuitry may be further configured to skip acquisition of at least a part of SI if time required for acquiring the SI is determined to be longer than the indicated maximum time duration. The explicit indication may be indicated by at least a spare bit or a new parameter in at least a MlB, a SIB of a serving cell, an area specific SIB, or a dedicated higher layer signaling.

The communication apparatus 1800, when in operation, provides functions required for optimising SI acquisition for NR devices. For example, the communication apparatus 1800 may be a base station or gNB, and the circuitry 1814 may, in operation, generate control information indicating a first period and/or second period; and the transmitter 1802 may, in operation, transmit the control information to a communication apparatus.

The communication apparatus 1800, when in operation, provides functions required for optimising SI acquisition for NR devices. For example, the communication apparatus 1800 may be a base station or gNB, and the circuitry 1814 may, in operation, generate control information indicating an explicit indication or a validity duration or timer for skipping acquisition of at least a part of SI; and the transmitter 1802 may, in operation, transmit the control information to a communication apparatus.

As described above, the embodiments of the present disclosure provide advanced communication methods and communication apparatuses that enable optimisation of SI acquisition for NR devices.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSls. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSls as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication apparatus.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such communication apparatus include a phone (e.g, cellular (cell) phone, smart phone), a tablet, a personal computer (PC) (e.g, laptop, desktop, netbook), a camera (e.g, digital still/video camera), a digital player (digital audio/video player), a wearable device (e.g, wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g, an appliance, lighting, smart meter, control panel), a vending machine, and any other “things” in a network of an “Internet of Things (loT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1. A communication apparatus comprising:
a receiver, which in operation, receives control information relating to a first period and/or a second period; and
circuitry, which in operation, acquires system information (SI) in the first period if a first condition is met, or acquires the SI in the second period if a second condition is met.

2. The communication apparatus according to claim 1, wherein the first period is a modification period and is not longer than the second period.

3. The communication apparatus according to claims 1 to 2, wherein a same content of the SI is mapped over the second period for the second condition.

4. The communication apparatus according to claims 1 to 3, wherein an interval to which a same content of the SI is mapped for the second condition is equal to or larger than that for the first condition.

5. The communication apparatus according to claims 1 to 3, wherein a number of repetitions of the SI in the second period is same as or is smaller than that in the first period.

6. The communication apparatus according to claims 1 to 5, wherein the first condition is that the communication apparatus is a first type of user equipment (UE) and the second condition is that the communication apparatus is a second type of UE.

7. The communication apparatus according to claim 6, wherein the first type of UE is a non-Reduced Capability (RedCap) UE and the second type of UE is a RedCap UE.

8. The communication apparatus according to claims 1 to 7, wherein a boundary of the first period is not greater than a boundary of the second period.

9. The communication apparatus according to claims 1 to 8, wherein the second period is a multiple of the first period.

10. The communication apparatus according to claims 1 to 8, wherein a maximum value of the second period is larger than a maximum value of the first period.

11. The communication apparatus according to claims 1 to 8, wherein the second period is a multiple of 40.96 s, wherein 40.96 s is a maximum duration of the first period.

12. The communication apparatus according to claims 1 to 8, wherein the second period is defined based on a longest duration of time required for RedCap UEs to acquire SI.

13. The communication apparatus according to claims 1 to 12, wherein the second period is indicated by at least a spare bit or a new parameter in a master information block (MIB), a system information block (SIB), or a dedicated higher layer signalling.

14. The communication apparatus according to claims 1 to 13, wherein the circuitry is further configured to acquire the SI in a certain time duration within the second period if the second condition is met.

15. The communication apparatus according to claims 1 to 13, wherein an interval to acquire the SI in the second condition is longer than that in the first condition.

16. The communication apparatus according to claims 1 to 13, wherein an interval to map the SI is same between the first condition and the second condition, and wherein the circuitry is further configured to acquire a part of the SI within the second period if the second condition is met.

17. The communication apparatus according to claims 1 to 13, wherein the circuitry is further configured to not acquire some repetitions of the SI that are transmitted in a certain time duration within the second period if the second condition is met.

18. The communication apparatus according to claims 1 to 5, wherein whether the second condition is met is determined by an explicit indication, a validity duration or a timer, such that the circuitry is configured to skip acquisition of at least a part of the SI when the explicit indication, validity duration or timer indicates that the SI is still valid.

19. The communication apparatus according to claims 1 to 5, wherein
the control information further indicates an explicit indication or a validity duration or timer; and
the circuitry is further configured to skip acquisition of at least a part of the SI based on the control information.

20. A communication apparatus comprising:
a receiver, which in operation, receives control information indicating an explicit indication or a validity duration or timer; and
circuitry, which in operation, skips acquisition of at least a part of SI based on the control information.

21. The communication apparatus according to claims 18 to 20, wherein the at least a part of the SI is a MIB, or a system information block type 1 (SIB1), or one or more SIBs other than SIB1.

22. The communication apparatus according to claims 18 to 20, wherein the validity duration or the timer is defined as L seconds, minutes, or hours.

23. The communication apparatus according to claims 18 to 20, wherein the validity duration or timer is a multiple of 3 hours.

24. The communication apparatus according to claims 18 to 20, wherein the circuitry is further (pre-)configured to delete a stored version of SI after the validity duration or timer has lapsed.

25. The communication apparatus according to claim 20, wherein the circuitry is further configured to not skip acquisition of at least a part of the SI if the validity duration or timer is not configured, and skips acquisition of at least a part of the SI if the validity duration or timer is configured as a predefined value.

26. The communication apparatus according to claims 18 to 20, wherein the circuitry skips acquisition of at least a part of SI based on the control information if it is further configured to trigger cell-reselection, return from out of coverage, or RRC re-establishment procedures.

27. The communication apparatus according to claims 18 to 20, wherein the circuitry is further configured to skip acquisition of at least a part of contents of SIB1 based on the control information.

28. The communication apparatus according to claims 19 and 20, wherein the explicit indication is a maximum time duration available for acquiring the SI, and wherein the circuitry is further configured to skip acquisition of at least a part of SI if time required for acquiring the SI is determined to be longer than the indicated maximum time duration.

29. The communication apparatus according to claims 18 and 20, wherein the explicit indication is indicated by at least a spare bit or a new parameter in at least a MIB, a SIB of a serving cell, an area specific SIB, or a dedicated higher layer signaling.

30. A base station comprising:
circuitry, which in operation, generates control information indicating a first period and/or second period; and
a transmitter, which in operation, transmits the control information to a communication apparatus.

31. A base station comprising:
circuitry, which in operation, generates control information indicating an explicit indication or a validity duration or timer for skipping acquisition of at least a part of SI; and
a transmitter, which in operation, transmits the control information to a communication apparatus.

32. A communication method comprising:
receiving control information indicating a first period and/or second period; and
acquiring SI based on the first period if a first condition is met, or acquiring SI based on the second period if a second condition is met.

33. A communication method comprising:
receiving control information indicating an explicit indication or a validity duration or timer for skipping acquisition of at least a part of SI; and
skipping acquisition of the at least a part of the SI based on the control information.

1. A communication apparatus comprising:
a receiver, which in operation, receives control information relating to a first period and/or a second period; and
circuitry, which in operation, acquires system information (SI) in the first period if a first condition is met, or acquires the Sl in the second period if a second condition is met.

2. The communication apparatus according to claim 1, wherein the first period is a modification period and is not longer than the second period.

3. The communication apparatus according to claims 1, wherein a same content of the Sl is mapped over the second period for the second condition.

4. The communication apparatus according to claims 1, wherein an interval to which a same content of the Sl is mapped for the second condition is equal to or larger than that for the first condition.

5. The communication apparatus according to claims 1, wherein a number of repetitions of the Sl in the second period is same as or is smaller than that in the first period.

6. The communication apparatus according to claims 1, wherein the first condition is that the communication apparatus is a first type of user equipment (UE) and the second condition is that the communication apparatus is a second type of UE.

7. The communication apparatus according to claim 6, wherein the first type of UE is a non-Reduced Capability (RedCap) UE and the second type of UE is a RedCap UE.

8. The communication apparatus according to claims 1, wherein a boundary of the first period is not greater than a boundary of the second period.

9. The communication apparatus according to claims 1, wherein the second period is a multiple of the first period.

10. The communication apparatus according to claims 1, wherein a maximum value of the second period is larger than a maximum value of the first period.

11. The communication apparatus according to claims 1, wherein the second period is a multiple of 40.96 s, wherein 40.96 s is a maximum duration of the first period.

12. The communication apparatus according to claims 1, wherein the second period is defined based on a longest duration of time required for RedCap UEs to acquire Sl.

13. A base station comprising:
circuitry, which in operation, generates control information indicating a first period and/or second period; and
a transmitter, which in operation, transmits the control information to a communication apparatus.

14. A communication method comprising:
receiving control information indicating a first period and/or second period; and
acquiring Sl based on the first period if a first condition is met, or acquiring SI based on the second period if a second condition is met.

15. A communication method comprising:
generating control information indicating a first period and/or second period; and
transmitting the control information to a communication apparatus.
